(19) United States
(12) Patent Application Publication
(10) Pub. No.: US 2010/0317772 A1
(43) Pub. Date: Dec. 16, 2010

(54) BIODEGRADABLE POLYMERIC COMPOSITIONS

(75) Inventor: Cun Ge LIN, Dalian City (CN)

Correspondence Address: FLEIT GIBBONS GUTMAN BONGINI & BIANCO P.L., ONE BOCA COMMERCE CENTER, 551 NORTHWEST 77TH STREET, SUITE 111, BOCA RATON, FL, 33487, US

(73) Assignee: Because We Care Pty Ltd., Derrimut (AU)

(21) Appl. No.: 12/562,514

(22) Filed: Sep. 18, 2009

(30) Foreign Application Priority Data
Jun. 16, 2009 (AU) 2009202397

(51) Int. Cl. C08L 3/00

(52) U.S. Cl. 524/47

(57) ABSTRACT

Biodegradable polymeric compositions suitable for use in forming films able to be used in one instance as shopping bags are disclosed. Some of the compositions contain mainly copolyesters, starch, polylactic acid, and glycerine.

### FIELD OF THE INVENTION

This invention relates to biodegradable polyester/starch polymeric compositions.

### BACKGROUND OF THE INVENTION

Starch/polyester compositions having some degradable characteristics are known, but these compositions only break down into small particles of plastics and only if exposed to ultraviolet light from natural sunlight. If buried in landfill, the degradation mechanism is blocked. Examples of starch/polyester compositions can be found in U.S. Pat. No. 5,334,634 and EP-A-0 327505.

However, there is currently a need for a biodegradable composition (as hereindefined) which in a thin-film has sufficient tear strength and high impact strength to meet the requirements for use as shopping bags.

The volume of plastic disposable shopping bags produced and used in Australia is well documented and in recent years has steadied at a little less than four billion bags per year. Similar large volumes of production of plastic disposable bags is also prevalent in many of the world's major industrialized countries, such as the United States of America. The magnitude of the problem of handling the responsible collection and disposal of such a number of bags is clear.

### SUMMARY OF THE INVENTION

It is an object of the present invention to address that problem by providing polymer compositions which are biodegradable (as hereindefined) which may be used to produce film for production of shopping bags, at a commercially viable cost per bag.

Throughout this specification, the term “biodegradable” means a composition which is compostable, that is, it will degrade back to its component parts or be digested by microbes when in a compost environment, within 60 days.

Certain preferred compositions of this invention are biodegradable within 45 days when in a compost environment.

### DETAILED DESCRIPTION

As required, detailed embodiments of the present invention are disclosed herein. However, it is to be understood that the disclosed embodiments are merely examples of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure and function. Further, the terms and phrases used herein are not intended to be limiting; but rather, to provide an understandable description of the invention.

According to the invention, there are provided polymer compositions comprising:

(a) From about 41 to about 66 wt % of an aliphatic-aromatic copolyester;

(b) from about 4.5 to about 18 wt % of polylactic acid;

(c) from about 22 to about 34 wt % of corn starch;

(d) from about 2.5 to about 3.5 wt % of glycerine;

(e) from about 1.5 to about 2.5 wt % of a lower alkyl ketose;

(f) from about 0.5 to about 1.5 wt % of a high molecular weight alkane;

and

(g) from about 0.8 to about 1.2 wt % of Bean oil;

in which the ratio of copolyester to polylactic acid by wt % is within the range of about 4:1 to about 10:1, and in which

the ratio of corn starch to polylactic acid by wt % is within the range of about 2:1 to about 5:1.

The copolyesters of the invention preferably contains terephthalate as the aromatic component, and a C₂ to C₆ lower alkylene adipate ester as the aliphatic component. More preferably the aliphatic component is a C₃ or C₄ lower alkylene adipate ester.

The preferred ketose is a C₄ to C₇ ketose, and more preferably a C₆ or C₇ ketose.

The preferred alkane is a C₂₀ to C₄₂ alkane, such as paraffin.

Various preferred compositions contain from about 51 to about 60 wt % copolyester, from about 5.5 to about 13.5 wt % polylactic acid, and from about 26 to about 30 wt % of corn starch.

The Australian Government has recently established Australian Standard (AS) 4736-2006 which specifies the requirements for a composition to be certified under that Standard as biodegradable. The AS 4736-2006 specifications were derived from similar standards for biodegradability set in Europe, United States of America and Japan.

Various preferred compositions of the present invention meet the requirements for certification under AS 4736-2006.

Examples of compositions in accordance with the invention are set out below.

### Example 1

51 kg of butylene adipate terephthalate copolyester and 5.5kg of polylactic acid were placed in a agitator and mixed for several minutes. 2.5 kg of glycerine, 1.5 kg of sorbose and 0.8 kg of Bean oil available from Sishui Shenyuan Bean Oil Factory in Shandong Province, China, were added to the agitator and mixed at low speed for several minutes to coat the granular material with the liquids. 22 kg of corn starch available from the Shandong HenRen Industry and Trading (Group) Co. Ltd, China, and 0.5 kg of paraffin were added to the agitator and mixed for a minute. Agitation then occurred at high speed for a minute before reducing the agitation to a stop.

The mixture was rested for several minutes and then agitated firstly at low speed and then at high speed by which time the components were fully mixed. The composition was then fed to an extruder for extrusion at a desired thickness.

### Example 2

60 kg of propylene adipate terephthalate copolyester, 13.5 kg of polylactic acid, 3.5 kg of glycerine and 1 kg of the Bean oil as used in Example 1 were placed in agitator and mixed for 15 minutes at low speed.

34 kg of corn starch as used in Example 1, 2.5 kg of sorbose and 1 kg of paraffin were added to the agitator and mixed at high speed for several minutes before being allowed to rest, with the agitator open to the atmosphere.

After re-sealing the agitator, the components were mixed again, firstly at low speed and then at high speed for two minutes before being transferred to an extruder for extrusion as a film.

### Example 3

The procedure used in Example 1 was repeated using 58 kg of butylene adipate terephthalate copolyester, 8 kg of polylactic acid, 30 kg of corn starch as used in Example 1, 3 kg of glycerine, 2 kg of sorbose, 1 kg of paraffin and 1 kg of Bean oil as used in Example 1.

Film produced from Examples 1-3 showed excellent tear and high impact strength and was capable of being formed into a plastic bag suitable for use as a shopping bag. The composition was also biodegradable (as hereindefined) in the form of a shopping bag.

Variations to the method of formulation described in the above Examples are within the scope of this application. For instance, components may be pre-mixed prior to addition to the agitator.

Where the terms “comprise”, “comprises”, “comprised” or “comprising” are used in this specification, they are to be interpreted as specifying the presence of the stated features, integers, steps or components referred to, but not to preclude the presence or addition of one or more other features, integers, steps, components to be grouped therewith.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. Biodegradable (as hereindefined) polymeric compositions comprising:
(a) from about 41 to about 66 wt % of an aliphatic-aromatic copolyester;
(b) from about 4.5 to about 18 wt % of polylactic acid;
(c) from about 22 to about 34 wt % of corn starch;
(d) from about 2.5 to about 3.5 wt % of glycerine;
(e) from about 1.5 to about 2.5 wt % of a lower alkyl ketose;
(f) from about 0.5 to about 1.5 wt % of a high molecular weight alkane;
and
(g) from about 0.8 to about 1.2 wt % of Bean oil;
in which the ratio of copolyester to polylactic acid by wt % is within the range of about 4:1 to about 10:1, and in which
the ratio of corn starch to polylactic acid by wt % is within the range of about 2:1 to about 5:1.

2. A bag made from a biodegradable composition as claimed in claim 1.

3. Biodegradable compositions as claimed in claim 1 wherein the copolyester is present in the amount of about 59 wt % and the polylactic acid is present in the amount of about 6 wt %.

4. A bag made from a biodegradable composition as claimed in claim 3.

5. Biodegradable compositions as claimed in claim 1 wherein the corn starch is present in the amount of about 28 wt % and the polylactic acid is present in the amount of from about 6 to about 18 wt %.

6. A bag made from a biodegradable composition as claimed in claim 5.

7. Biodegradable compositions as claimed in claim 1 wherein the copolyester is a lower alkylene adipate terephthalate copolyester.

8. A bag made from a biodegradable composition as claimed in claim 7.

9. Biodegradable compositions as claimed in claim 1 wherein the lower alkyl ketose is a C₆ or C₇ ketose.

10. A bag made from a biodegradable composition as claimed in claim 9.

11. Biodegradable compositions as claimed in claim 1 which are certifiable under (AS) 4736-2006.

12. A bag made from a biodegradable composition as claimed in claim 11.

13. Biodegradable compositions as claimed in claim 1 which are certifiable under standards for biodegradability set in the United States of America that are similar to certification under AS 4736-2006.

14. A bag made from a biodegradable composition as claimed in claim 13.
